(19) United States
(12) Patent Application Publication
(10) Pub. No.: US 2009/0213038 A1
(43) Pub. Date: Aug. 27, 2009

(54) Head Mounted Display and Real-Time Video Device

(76) Inventors: Joseph Huang, Taoyuan (TW); Jonathan Lau, Taoyuan (TW)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/036,884

(22) Filed: Feb. 25, 2008

(51) Int. Cl. G09G 5/00

(52) U.S. Cl. 345/8; 348/294

(57) ABSTRACT

A head mounted display is disclosed in this invention. The head mounted display includes a display module, a removable supporting frame, and a removable clamping device. The display module is connected to a multi-media player. The removable supporting frame is disposed on the display module. The removable clamping device is disposed on the display module so as to clip eyeglasses of a user. A real-time video device is also disclosed in this invention. The real-time video device includes an image capturing device, a receiving device, and a head mounted display. The image capturing device is able to capture a motion image of a user continuously and transfer a signal of the motion image. The receiving device is used to receive the signal of the motion image. The head mounted display is mounted on the head of the user; the motion image is displayed on a display element of the head mounted display instantaneously.

### BACKGROUND OF THE INVENTION

1. Field of the Invention

The present invention generally relates to a head mounted display, and more particularly to a head mounted display which is able to clip on eyeglasses.

2. Description of the Prior Art

As the technology becomes advanced, the request for information of consumers also increases. However, the conventional display is not portable. The conventional portable electronic product only has a small display, the visional effect of the small display is poor. It is easy to make the eyes of the user tired for long time use.

The conventional head mounted display is like a pair of heavy eyeglasses, and the conventional head mounted display is mounted on the head of the user by two supporting frames. The fixing method of the conventional head mounted display is suitable for the user without eyeglasses. But the fixing method of the conventional head mounted display is not suitable for the user with eyeglasses; the supporting frames of the conventional head mounted display are interfered with the eyeglasses of the user. The user with eyeglasses will feel uncomfortable with the fixing method of the conventional head mounted display. Moreover, when performing sport practice, it is necessary to adjust the motion so as to improve the result of the sport practice. For example, when performing sport practice of striking a baseball or a golf ball, because the striker is not able to see the striking motion instantaneously, the striker can adjust the striking motion by the trace of the ball which has been struck or by instructions of a coach. Or the striker can adjust the striking motion after the sport practice by a video camera which stores the motion images of the striker. There are some disadvantages of the prior art mentioned above, it is necessary to use a large field to adjust the striking motion by the trace of the ball, and the weather affects the trace of the ball. It is not possible to adjust the striking motion instantaneously by a video camera or by instructions of a coach.

For the reason that there are some disadvantages of the prior art mentioned above, there is a need existed to propose a novel head mounted display. The head mounted display is able to clip on eyeglasses of the user. The user with eyeglasses will not feel uncomfortable with the fixing method of the head mounted display, and the head mounted display is also suitable for the user without eyeglasses. There is another need also existed to propose a novel real-time video device. By the real-time video device, the user is able to see the motion of the user instantaneously so as to perform sport practice.

### SUMMARY OF THE INVENTION

Accordingly, the present invention has been made in order to meet such a need described above, and it is an object of the present invention to provide a head mounted display, the head mounted display is able to clip on eyeglasses of the user, the user with eyeglasses will not feel uncomfortable with the fixing method of the head mounted display, and the head mounted display is also suitable for the user without eyeglasses.

It is another object of the present invention to provide a real-time video device. By the real-time video device, the user is able to see the motion of the user instantaneously so as to perform sport practice.

In order to achieve the above objects, the present invention provides a head mounted display. The head mounted display includes a display module, a removable supporting frame, and a removable clamping device. The display module is connected to a multi-media player. The removable supporting frame is disposed on the display module. The removable clamping device is disposed on the display module so as to clip eyeglasses of a user.

The present invention also provides a real-time video device. The real-time video device includes an image capturing device, a receiving device, and a head mounted display. The image capturing device is able to capture a motion image of a user continuously and transfer a signal of the motion image. The receiving device is used to receive the signal of the motion image. The head mounted display is mounted on the head of the user; the motion image is displayed on a display element of the head mounted display instantaneously.

### BRIEF DESCRIPTION OF THE DRAWINGS

FIG. 1A shows the top view of a head mounted display in accordance with a preferred embodiment of the present invention;

FIG. 1B shows the front view of the head mounted display shown in FIG. 1A;

FIG. 2A shows the perspective view of a real-time video device in accordance with a preferred embodiment of the present invention; and

FIG. 2B shows the perspective view of the real-time video device shown in FIG. 2A.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

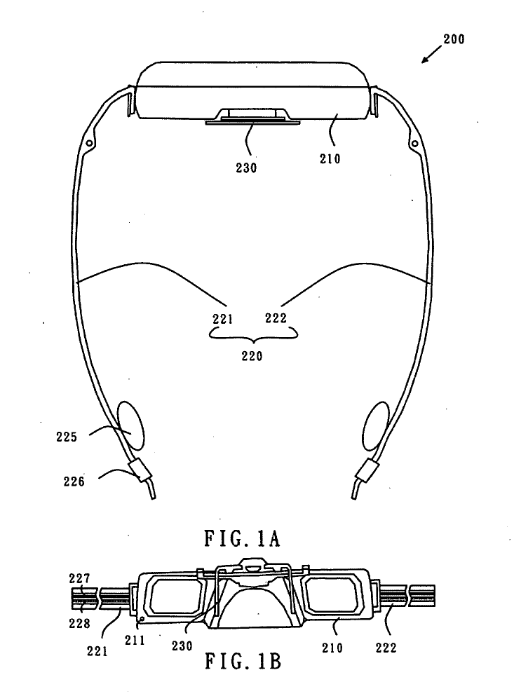

FIG. 1A shows the top view of a head mounted display in accordance with a preferred embodiment of the present invention. The head mounted display 200 includes a display module 210, removable supporting frames 220, and a removable clamping device 230. The display module 210 is connected to a multi-media player (not shown), the display module 210 is used to display the image transferred from the multi-media player. The removable supporting frames 220 includes a left supporting frame 221 and a right supporting frame 222 which are disposed at two sides of the display module 210 respectively. The removable clamping device 230 is used to clip eyeglasses of a user.

When the user has eyeglasses, the removable supporting frames 220 are removed so as to fix the display module 210 on the eyeglasses of the user by the removable clamping device 230. When the user has no eyeglasses, the removable clamping device 230 is removed so as to fix the display module 210 on the user by the removable supporting frames 220.

According to this embodiment, the multi-media player mentioned above is a video player, for example, the multi-media player could be a DVD video player, a MP4 video player, or a VCD video player, but not limited to this, the multi-media player mentioned above could be a notebook computer, a PDA (Personal Digital Assistant), a mobile phone, or other portable electronic products.

The removable supporting frames 220 can further include a pair of earphones 225 which are disposed in positions on the left supporting frame 221 and the right supporting frame 222 corresponding to the ear of the user respectively.

The removable supporting frames 220 can further include a pair of weights 226 so as to balance the weight of the display module 210. According to this embodiment, the weights 226 are disposed on the ends of the left supporting frame 221 and the right supporting frame 222, but not limited to this, the weights 226 are also able to be disposed in any other positions.

FIG. 1B shows the front view of the head mounted display shown in FIG. 1A. The display module 210 has an earphone connector 211. When the user has eyeglasses, the removable supporting frames 220 are removed. The display module 210 is fixed on the eyeglasses of the user by the removable clamping device 230, and the user is able to connect the connecting wires of a pair of traditional earphones to the earphone connector 211.

Each earphone 225 has two connecting wires 227/228. According to this embodiment, the removable supporting frame 220 is made of a material which is able to conduct electricity. Therefore, the removable supporting frame 220 is able to be used as a connecting wire of the earphone 225. When removable supporting frame 220 is connected to the display module 210, the connecting wires 227/228 of the earphone 225 is capable of inserting into a connector disposed on the display module 210.

By using the head mounted display of the present invention, because the head mounted display is able to clip on eyeglasses of the user, the user with eyeglasses will not feel uncomfortable with the fixing method of the head mounted display. The head mounted display of the present invention is also suitable for the user without eyeglasses.

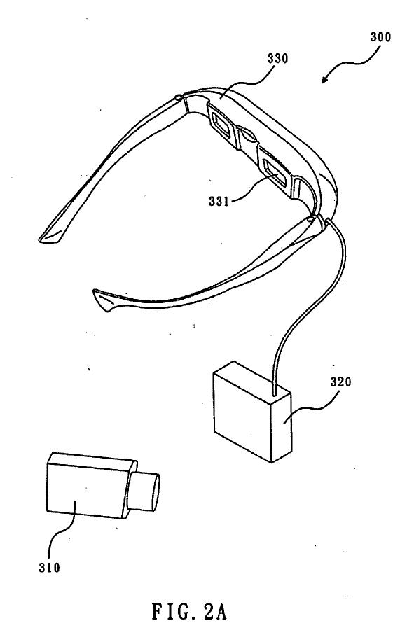

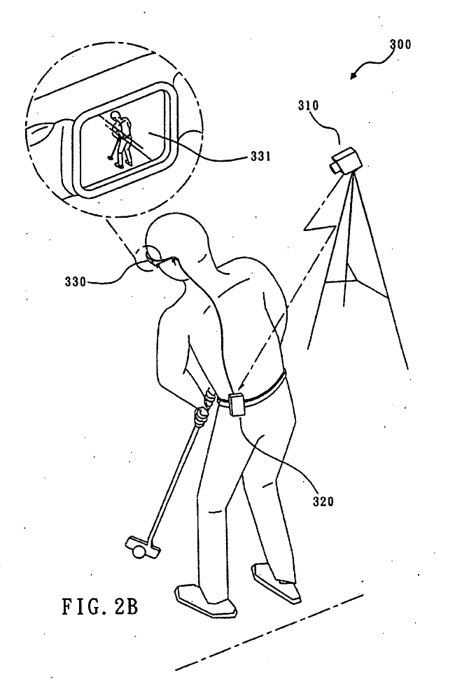

FIG. 2A shows the perspective view of a real-time video device in accordance with a preferred embodiment of the present invention. The real-time video device 300 includes an image capturing device 310, a receiving device 320, and a head mounted display 330. The image capturing device 310 is able to capture a motion image of a user continuously and transfer a signal of the motion image by a wired transmission or a wireless transmission. The receiving device 320 is carried by the user so as to receive the signal of the motion image. The head mounted display 330 is mounted on the head of the user and the head mounted display 330 is connected to the receiving device 320. The head mounted display 330 includes an electronic circuit (not shown), the signal of the motion image is processed by the electronic circuit and the motion image is displayed on a display element 331 of the head mounted display 330 instantaneously. Then the user is able to see the motion image which is captured by the image capturing device 310 instantaneously.

According to this embodiment, the signal of the motion image between the image capturing device 310 and the receiving device 320 is transferred by a wired transmission or a wireless transmission. Moreover, the signal of the motion image between the receiving device 320 and the head mounted display 330 is also transferred by a wired transmission or a wireless transmission.

According to this embodiment, the image capturing device 310 includes a CCD (Charge Coupled Device), but not limited to this, the image capturing device 310 can include a CMOS (Complementary Metal-Oxide Semiconductor) or any other device which is able to capture an image.

According to this embodiment, the display element 331 of the head mounted display 330 includes a TFT-LCD (thin-film transistor liquid-crystal display), but not limited to this, the display element 331 can include an OLED (Organic Light Emitting Display) or any other element which is able to display an image.

According to this embodiment, the head mounted display 330 can include a lens so as to enlarge the motion image, whereby the user is able to see the enlarged motion image of the user so as to adjust the motion. But not limited to this, the display element 331 can include no lens; the motion image is enlarged by a signal process which is performed by the electronic circuit. The head mounted display 330 is also able to have no function of image enlarging.

According to this embodiment, the image capturing device 310 is able to include a storing device (not shown) so as to store the motion image. The storing device can be installed in a computer or any other device which is able to store images.

FIG. 2B shows the perspective view of the real-time video device shown in FIG. 2A. When a user performs sport practice by the real-time video device 300, for example, the user performs striking practice of baseball or golf. Because the user is able to see the striking motion of the user instantaneously by the real-time video device 300, the user is able to adjust the striking motion instantaneously. The user is also able to see the striking motion and adjust the striking motion by the storing device when the sport practice is finished. Therefore, there is no need to use a large field to perform sport practice, and the weather will not affect the result of sport practice. It is also possible to perform sport practice without a coach.

Although specific embodiments have been illustrated and described, it will be appreciated by those skilled in the art that various modifications may be made without departing from the scope of the present invention, which is intended to be limited solely by the appended claims.

What is claimed is:

1. A head mounted display, comprising:
a display module;
two removable supporting frames, and said removable supporting frames are disposed at two sides of said display module; and
a removable clamping device, and said removable clamping device are disposed on said display module so as to clip eyeglasses of a user.

2. The head mounted display according to claim 1, wherein said display module is connected to a multi-media player.

3. The head mounted display according to claim 2, wherein said multi-media player is a DVD video player, a MP4 video player, a VCD video player, a notebook computer, a PDA (Personal Digital Assistant) or a mobile phone.

4. The head mounted display according to claim 1, wherein said removable supporting frames are removable so as to fix said display module on said eyeglasses of said user by said removable clamping device.

5. The head mounted display according to claim 1, wherein said removable clamping device is removable so as to fix said display module on said user by said removable supporting frames.

6. The head mounted display according to claim 1, wherein said removable supporting frame comprises an earphone.

7. The head mounted display according to claim 6, wherein said earphone comprises two connecting wires, and said connecting wires are connected to said display module.

8. The head mounted display according to claim 6, wherein said removable supporting frame is made of a conductive material, and said removable supporting frame is used as a connecting wire of said earphone.

9. The head mounted display according to claim 1, wherein said display module comprises an earphone connector.

10. The head mounted display according to claim 1, wherein said removable supporting frame comprises a weight, and said weight is disposed on one end of said removable supporting frame so as to balance the weight of said display module.

11. A real-time video device, comprising:
an image capturing device, and said image capturing device is able to capture a motion image of a user continuously and transfer a signal of said motion image;
a receiving device, and said receiving device is used to receive said signal of said motion image; and
a head mounted display, and said head mounted display is mounted on the head of said user, wherein said motion image is displayed on a display element of said head mounted display instantaneously.

12. The real-time video device according to claim 11, wherein said head mounted display comprises:
a display module;
two removable supporting frames, and said removable supporting frames are disposed at two sides of said display module; and
a removable clamping device, and said removable clamping device is disposed on said display module so as to clip eyeglasses of said user.

13. The real-time video device according to claim 11, wherein said image capturing device transfers said signal of said motion image by a wired transmission or a wireless transmission.

14. The real-time video device according to claim 11, wherein said receiving device is connected to said head mounted display by a wired transmission or a wireless transmission.

15. The real-time video device according to claim 11, wherein said image capturing device comprises a CCD (Charge Coupled Device) or a CMOS (Complementary Metal-Oxide Semiconductor).

16. The real-time video device according to claim 11, wherein said display element comprises a TFT-LCD (thin-film transistor liquid-crystal display) or an OLED (Organic Light Emitting Display).

17. The real-time video device according to claim 11, wherein said head mounted display further comprises an electronic circuit so as to process said signal of said motion image.

18. The real-time video device according to claim 11, wherein said head mounted display further comprises at least one lens so as to enlarge said motion image.
